(19) United States
(12) Patent Application Publication
(10) Pub. No.: US 2014/0200490 A1
(43) Pub. Date: Jul. 17, 2014

(54) POST KNEE SURGERY PHYSICAL THERAPY DEVICE

(71) Applicant: Harold Kie, Long Beach, CA (US)

(72) Inventor: Harold Kie, Long Beach, CA (US)

(21) Appl. No.: 13/743,188

(22) Filed: Jan. 16, 2013

(51) Int. Cl. A61H 1/00

(52) U.S. Cl. CPC A61H 1/008
USPC 601/5

(57) ABSTRACT

A physical therapy device including a vertically elongated lever arm turned to project medially on the upper and lower extremities to form repetitive thigh and ankle bearing rods and further including an elongated crank.

### BACKGROUND OF THE INVENTION

The present invention relates to physical therapy for patient's knee prosthesis.

### DESCRIPTION OF PRIOR ART

Great strides have been made in knee replacement surgery. Knee replacement is particularly applicable for those suffering from stiff painful knees which make it difficult to perform normal activities. In the process, an incision may be made in the front of the knee and the damaged joint removed from the surface of the bones and those surfaces shaped to hold a metal or plastic knee prosthesis. The artificial joint may be attached to the thigh bone, skin and knee cap either with cement or a special bonding material. More recently, minimally invasive surgery has revolutionized knee replacement allowing to make the surgery without a large incision. After a hospital stay of just 1, 2 or 3 days the patient may see dramatic improvement.

A post-operative exercise and therapy program is important for maintaining flexibility and inducing complete healing and knee motion. Surgeons will prescribe various home exercises or mechanical devices to slowly move the knee for a passive or resisted motion. Various different exercises or therapies are prescribed, including laying with one's back on the floor or a table and, for instance, holding the ends of a towel wrapped around the forefoot and flexing the ankle and knee against a resistive force. Other exercises involve laying on one's back in placing the foot of the injured leg against the wall and seeking to perform exercises against the resistance of the wall at various elevations.

Other techniques are considered for influencing full extension and traction of the knee, typically involving moving to different positions and sometimes using various machine device for resisting the knee flexing with controlled weights or resistance springs or the like. One exercise involves grasping the back of the chair or table and making an effort to completely straighten the knee. Another exercise prescribed is for the patient to lay flat on his or her back and seek to flex the knee downward against the floor or table and holding the contraction for a period of time as for 5 seconds repeating maybe 5 to 10 times. Other efforts to improve the range of motion involves lying flat with a rolled towel or round pillow under the knee and extending the knee so the foot rises completely off the floor and holding the foot elevated.

Efforts have been made to persuade patients to utilize exercise equipment at exercise centers endeavoring to strengthen or flex the knees but generally, these devices are not accessible to many patients and do not provide the tool beneficial for disciplining the therapy sessions.

Numerous different efforts have been made to devise various types of crutches and crutch attachments supporting an injured limb or the like during the recovery period. See, for example, U.S. Pat. No. 6,932,096 to Marek, U.S. Pat. No. 8,215,325 to Montanti and U.S. Pat. No. 8,047,216 to Parry. None of these devices focus on leverage for facilitating the flexing of a new prosthesis in one direction or the other.

### SUMMARY OF THE PRESENT INVENTION

The device of present invention includes an elongated lever arm to span between the ankle and the thigh adjacent a knee prosthesis and including a laterally projecting thigh bearing rod for engaging the front of the thigh and a laterally projecting ankle bearing rod for engaging the back of the ankle. The device further includes an upwardly projecting handle to be grasped by the patient so that he or she can rotate the device about the thigh bearing to rotate the ankle forwardly thus repeatedly tending to straighten the knee to the extent the patient can withstand the discomfort to thereby increase flexibility. In an alternative application, the thigh bearing may be positioned behind the thigh and the ankle bearing in front of the ankle so the handle may be rotated forwardly to orbit the lower leg upwardly around the knee prosthesis.

### BRIEF DESCRIPTION OF THE DRAWINGS

FIG. 1 is a perspective view of a therapy device embodying my invention;

FIG. 2 is a front view in enlarged scale of the device shown in FIG. 1;

FIG. 3 is a side view of the device shown in FIG. 2;

FIG. 4 is a side view similar to FIG. 2 and showing the device in use applying therapy to a patients knee prosthesis; and

FIG. 5 is a view similar to FIG. 4 but showing the device applying therapy to flex the prosthesis to a bent position.

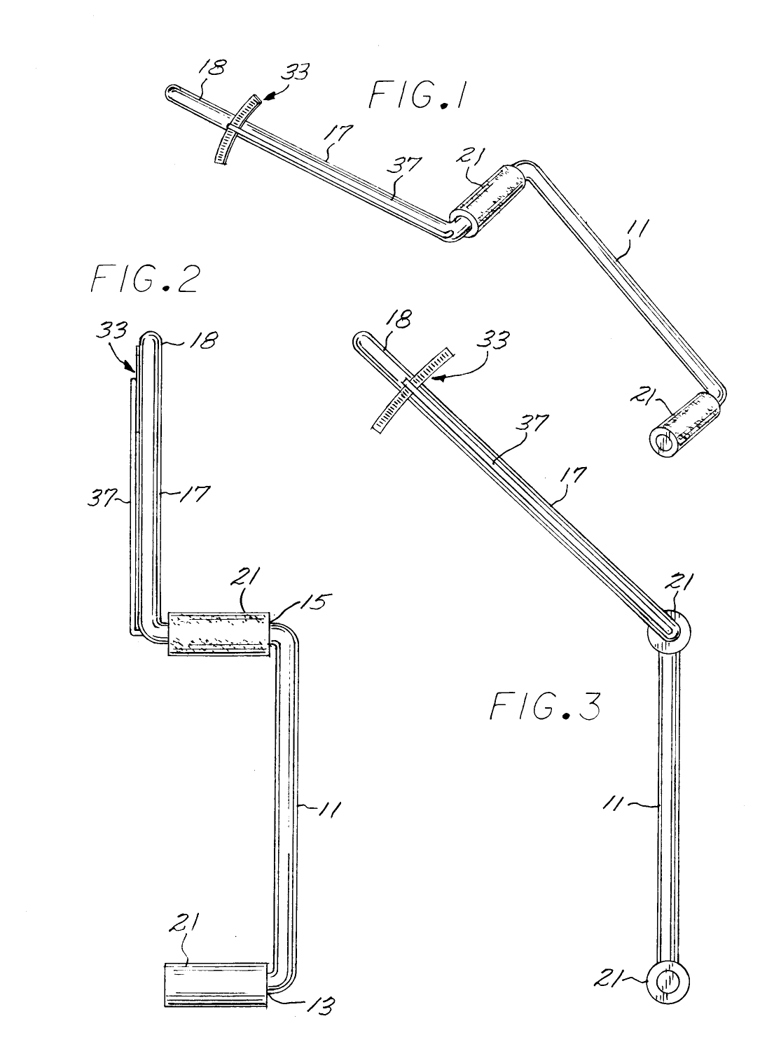

### DETAILED DESCRIPTION OF THE PREFERRED EMBODIMENTS

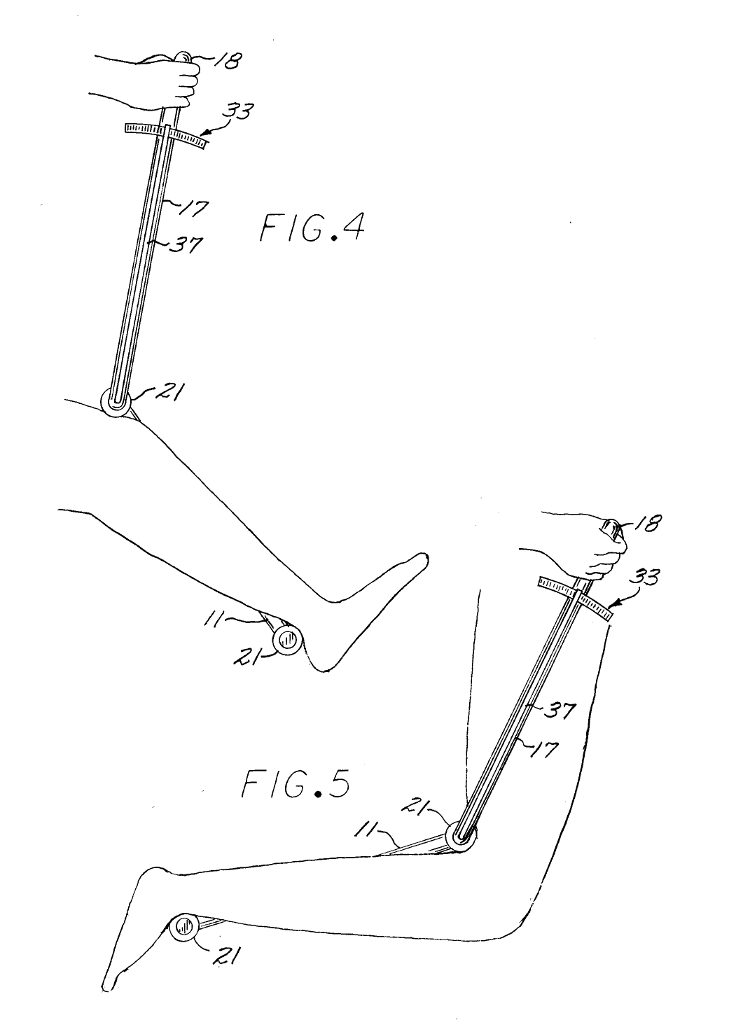

The therapy device of the present invention is intended for use by a patient 10 having had a knee replacement necessitating therapy to maintain or induce stretching and flexibility in and around the knee joint. In my exemplary embodiment, I have elected to disclose a therapy device for treating the right leg of the patient, it being appreciated that the embodiment for treating the left leg would be a minor image. The device includes, generally, a vertically elongated lever arm 11 to flank the side of the patient's leg and is somewhat in the form of a modified U-shape to be configured at its respective upper and lower extremities with inwardly turned thigh and ankle bearings 13 and 15 to be engaged, respectively, with, for instance, the lower front of the thigh and back of the ankle. Projecting upwardly from the distal end of the bearing 13 is a handle crank 17 configured to project upwardly from the lower front of the patient's thigh and formed at its upper extremity with a handle 18 for grasping by the user. Thus, the user may grasp the handle 18 as shown in FIG. 1 to engage the bearing 13 against the anterior of the lower thigh or knee area, the bearing 15 behind the ankle and the crank 17 rotated counter clockwise about the bearing 13 (FIG. 4) to rotate the lever arm counter clockwise to drive the ankle forward relative to the thigh thereby flexing the knee joint and surrounding tissues, muscles and ligaments to the extent the patient can tolerate the discomfort. This procedure will be repeated and repetitions increased as the recovery progresses.

In the recovery from a knee transplant, it is important that the patient engage in regular therapy to maintain flexibility of the knee joint. To induce this therapy, it is important that any tool utilized be compact, convenient to use, and readily available for the patient. It is to this procedure that the present device is directed.

The device of the present invention may be constructed of any desirable materials, such as rigid or semi rigid thermoplastic, metal, wood or other materials readily available having durability and relatively lightweight for convenient manipulation and use.

In the preferred embodiment the device is constructed of thick walled thermoplastic tubing and the lever 11 is approximately 14 inches long for spanning the knee joint and the tibia of an adult male. The lever arm is formed on its upper and lower ends with respective in-turned rods defining the respective bearings 13 and 15. In the preferred embodiment, the bearings are encased with a foam rubber 21 to provide padding for contact with the patient.

The device may be formed with threaded or soldered corner elbows and in some configurations is formed as by bending or cold working.

Referring to FIG. 3, supported from the medial end of the bearing 13 is the elongated crank 17, approximately 17 inches long and formed at its distal extremity with the handle 18 which, in some configurations, is of enlarged diameter for convenient grasping. For this right hand device, the crank angles upwardly to the left (FIG. 3) at an angle between 100° and 170° and lower arm 11 and preferable between 125° and 145°. In the preferred embodiment, the crank extends at an angle of 135° to the lever arm.

I have tested my invention under doctor's supervision and, in treating multiple knee transplants, have found it to be particularly effective in flexing the joint and exercising the knee. An advantage of one of the embodiments of my invention is that it can be utilized to either flex the lower leg forwardly (FIG. 4) or flex rearwardly (FIG. 5). In one method, I grasp the handle 18 and engage the bearing 13 on the lower thigh just above the kneecap and insert the bearing 15 behind, or posterior, of the ankle as shown in FIG. 4. I then raise the foot off the floor and, while in a standing position grasping a rail, doorknob or the like to steady myself, I rotate the crank 17 counter clockwise to rotate the lever 11 clockwise around the bearing 13 to drive the ankle forwardly thus flexing the knee towards the straightened position. I repeat this for several times, as for instance 10 times, limited only by the extent to which I can withstand the discomfort from this flexing. Over a period of a few days, weeks or months, I have found that the knee joint them becomes even more flexible. I have found the device can be used several timer per day and that repetitive use accelerates healing and flexibility.

In other methods, I have been able to induce flexibility of the prosthesis to a bent position as shown in FIG. 5. For this technique I insert the bearing 13 behind or immediately above the knee and insert the lower bearing 13 in front of the ankle maintaining a grasp on the handle 18. I then rotate the handle and crank 17 clockwise to rotate the lever arm 11 clockwise about the bearing 15 to thus flex the ankle upwardly by bending the knee to a degree to which I could withstand the discomfort. I repeat this for 10-15 times or more several times a day. In comparing my recovery time with that of others who have not had the benefit of my invention, I discovered that my recovery time has been accelerated and flexibility of the new prosthesis improved over that of others.

The preferred embodiment incorporates a torque arm 31 projecting upwardly from the bearing 15 along the lever arm 17 for about a foot or so. I mount an arcuate scale 33 on the lever arm with indicia 35 corresponding with the magnitude to which the lever 17 is flexed relative to the torque arm to give an indication of the magnitude of torque applied to the knee joint. In many applications, the therapist will prescribe the magnitude of torque to be applied as an objective for the recovery.

It will be appreciated that the device shown in the exemplary embodiment is particularly applicable for treating the right knee of a patient. The device for treating the left leg will be a mirror image to position the lever arm 11 laterally on the patient's left tibia and the crank 17 distally of the vertical plane of the patient's thigh.

Although the present invention has been described in detail with regard to the preferred embodiments and drawings thereof, it should be apparent to those of ordinary skill in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention.

I claim:

1. A knee physical therapy device for flexing a patient's knee and comprising:
a vertical lever arm to span along the side of the patient's leg adjacent a knee prosthesis from the thigh to the ankle and having and upper and lower extremities;
a transverse thigh bearing rod projecting laterally in one direction from the upper extremity for contacting the patients thigh and having a medial extremity;
a transverse ankle bearing rod projecting laterally in the one direction from the lower extremity; and
a crank projecting upwardly from the medial extremity and terminating in a handle whereby the thigh bearing rod may be positioned anterior on the patient's thigh above the knee prosthesis and the ankle bearing rod positioned posterior on the patient's ankle so the handle may be grasped and the lever rotated in one direction to rotate the lever around the thigh bearing rod to rotate the lever in the one direction to drive the ankle forwardly relative to the knee to flex the knee prosthesis.

2. The physical therapy device of claim 1 wherein:
the lever arm is substantially 14 inches long.

3. The physical therapy device of claim 1 wherein:
the crank is substantially 17 inches long.

4. The physical therapy device of claim 1 wherein:
the lever arm is constructed of metal tubing.

5. The physical therapy device of claim 1 that includes:
a torque meter device for measuring the torque applied to the crank.

6. The physical therapy device of claim 1 wherein:
the lever, crank and rods are configured to selectively receive the patient's leg to position the thigh bearing rod posterior of the knee and the ankle bearing rod interior of the ankle.

7. The physical therapy device of claim 1 that includes:
the lever arm and crank are constructed of metal.

8. The physical therapy device of claim 1 that includes:
cushioning pads on the bearing rods.

9. The physical therapy device of claim 1 for treating the right knee of a patient wherein:
with the device positioned with the thigh bearing on the lower thigh of the right leg, and the lever arm positioned laterally of the patient's tibia, the bearings projecting distally to engage, respectively, the lower anterior thigh and posterior the patient's ankle.

10. The physical therapy device of claim 1 wherein:
the bearing rods project laterally at an angle of 90° to the lever arm; and
the crank projects at an angle of between 100° and 170° to the lever arm.

11. The physical therapy device of claim 1 wherein:
the crank projects at an angle of substantially 135° to the lever arm

12. A knee physical therapy device for flexing a patient's knee and comprising:
a vertical lever arm substantially 14 inches long for flanking along the side of a patient's tibia adjacent a knee prosthesis and having upper and lower extremities;
a transverse thigh bearing rod projecting medially from the upper extremity and including a cushioning pad configured to contact the patient's thigh;
a transverse ankle bearing rod projecting immediately from the lower extremity and including a cushioning pad for contacting the back of the patient's ankle; and
a handle crank substantially 17 inches long projecting upwardly from the medial extremity of the thigh bearing rod and terminating in a handle.

13. The physical therapy device of claim 12 wherein:
the lever arm and crank are constructed of metal.

14. The physical therapy device of claim 12 wherein:
the crank projects at an angle of substantially 135° to the lever arm.

15. A method for applying therapy to a patient's knee prosthesis and including:
selecting a therapy device including a lever arm for projecting laterally along the knee and along the patient's tibia and formed at upper and lower extremities medially projecting thigh and ankle bearing rods;
positioning lever along the lateral side of the tibia and positioning of the thigh bearing anterior on the patient's thigh above the knee and the ankle bearing posterior of the patient's ankle; and
rotating the lever arm around the thigh bearing to drive the ankle bearing forwardly to flex the knee to its' extended position.

16. The method of claim 15 that includes:
rotating the lever arm around the thigh bearing 10 times.

17. The method of claim 15 that includes:
the step of repositioning the thigh bearing posterior of the knee and the ankle bearing anterior of the ankle and rotating the lever arm to drive the ankle rearward relative to the knee.
